(19) United States
(12) Patent Application Publication
(10) Pub. No.: US 2017/0057642 A1
(43) Pub. Date: Mar. 2, 2017

(54) AIRCRAFT AIR CONDITIONING SYSTEM FOR CONNECTION TO AN AIRCRAFT-EXTERNAL AIR PRODUCTION UNIT

(71) Applicant: AIRBUS OPERATIONS GMBH, Hamburg (DE)

(72) Inventor: Frank KLIMPEL, Hamburg (DE)

(21) Appl. No.: 15/247,004

(22) Filed: Aug. 25, 2016

(30) Foreign Application Priority Data
Aug. 26, 2015 (DE) 10 2015 216 247.8

(51) Int. Cl. B64D 13/06

(52) U.S. Cl. CPC B64D 13/06; B64D 2013/0611; B64D 2013/0618; B64D 2013/0688

(57) ABSTRACT

An aircraft air conditioning system includes an air conditioning unit for the production of air conditioning air, which unit is connected to a pack air line, a recirculation air line adapted to be flown through with recirculation air and a mixing chamber, which is connected to the pack air line and the recirculation air line. An inlet line is connected to a connection on the aircraft for an aircraft-external air production unit and opens into the pack air line connecting the air conditioning unit to the mixing chamber. An air conditioning air line branches off from the pack air line between an opening point of the inlet line into the pack air line and the mixing chamber and is connectable to an aircraft area to be cooled.

### CROSS-REFERENCE TO RELATED APPLICATION

This application claims priority to German Patent Application DE 10 2015 216 247.8 filed Aug. 26, 2015, the entire disclosure of which is incorporated by reference herein.

### TECHNICAL FIELD

The present disclosure relates to an aircraft air conditioning system that is connectable to an aircraft-external air production unit and a system for cooling an aircraft area, which system comprises such an aircraft air conditioning system as well as an aircraft-external air production unit. The disclosure herein further relates to a method for operating such a system.

### BACKGROUND

Currently used aircraft air conditioning systems comprise a mixing chamber, to which very cold air at a temperature of down to approximately −15° C. is supplied by air conditioning units of the aircraft air conditioning system, the so-called packs, in operation of the aircraft air conditioning system. Warm recirculation air at a temperature of approximately +30° C., which is led away from at least one of the aircraft areas to be air conditioned, for example a passenger cabin of the aircraft, is also conducted into the mixing chamber. The air mixed in the mixing chamber is then supplied via various air distribution lines to the aircraft areas to be air conditioned, for example the passenger cabin and the hold. Aircraft areas to which air conditioning air must be conducted at a temperature that is lower than the temperature of the mixed air leaving the mixing chamber, such as certain hold areas, for example, are supplied with air conditioning air via a separate air conditioning air line, which branches off upstream of the mixing chamber from a pack air line connecting an air conditioning unit to the mixing chamber.

During operation, the air conditioning units of the aircraft air conditioning system are supplied with highly compressed process air, which is provided by the engines or the auxiliary power unit (APU) of the aircraft or by a compressor formed separately from the engines and the auxiliary power unit. To minimize the fuel consumption of the engines and the auxiliary power unit it is usual, however, to provide aircraft with precooled air in ground operation, which air is provided by an aircraft-external air production unit normally formed as a low-pressure air production unit. Aircraft-external air production units are normally connected by connection pipes to connections on the aircraft, which are connected to the mixing chamber of the aircraft air conditioning system, so that cold air produced by an aircraft-external air production unit is conducted directly into the mixing chamber. A configuration of this kind is described for example in EP 2 401 201 B1 or US 2012/064816 A1.

The supplying of cold air produced by an aircraft-external air production unit directly to the mixing chamber of the aircraft air conditioning system has the result, however, that aircraft areas to which air conditioning air must be conducted at a temperature that is lower than the temperature of the mixed air leaving the mixing chamber cannot be cooled by the aircraft-external air production unit. On the contrary, for adequate cooling of these aircraft areas even in ground operation of the aircraft, it is necessary to continue to operate at least the air conditioning unit of the aircraft air conditioning system, which unit is connected via the pack air line that connects the air conditioning unit to the mixing chamber and the separate air conditioning air line branching off from this pack air line upstream of the mixing chamber to the aircraft area to be air conditioned.

### SUMMARY

The disclosure herein is directed toward the task of specifying an aircraft air conditioning system connectable to an aircraft-external air production unit and a system for cooling an aircraft area, which facilitate an energy-efficient supply of air conditioning air to an aircraft area that is to be cooled to a low temperature. Furthermore, the disclosure herein is directed toward the task of providing a method for operating such a system for cooling an aircraft area.

This task is solved by an aircraft air conditioning system, a system for cooling an aircraft area and a method for operating an aircraft air conditioning system with the features disclosed herein.

An aircraft air conditioning system comprises at least one air conditioning unit, a so-called pack, for producing air conditioning air. An inlet side of the air conditioning unit is preferably connected via a process air line to an engine, an auxiliary power unit or a compressor formed separately from the engine and the auxiliary power unit, so that highly compressed process air can be supplied to the air conditioning unit via the process air line. In the air conditioning unit, the process air is cooled and expanded on flowing through at least one heat exchanger unit as well as various compression and expansion units. An outlet side of the air conditioning unit is connected to a pack air line. Cooled pack air emerging from the air conditioning unit is led away from the air conditioning unit via the pack air line. The air conditioning unit preferably supplies air at a temperature of approximately −15° C.

The aircraft air conditioning system further comprises a recirculation air line adapted to be flown through with recirculation air can flow. The recirculation air line is used to lead recirculation air away from an air-conditioned aircraft area, for example an aircraft passenger cabin. The recirculation air flowing through the recirculation air line normally has a temperature of approximately +30° C. To convey the recirculation air through the recirculation air line, the aircraft air conditioning system may comprise at least one recirculation air conveying device formed, for example, in the form of a fan.

A mixing chamber of the aircraft air conditioning system is connected to the pack air line and the recirculation air line. In the mixing chamber, mixing takes place of the cool pack air produced by the air conditioning unit with the comparatively warm recirculation air led away from the air-conditioned aircraft area. Mixed air emerging from the mixing chamber consequently has a temperature that lies between the temperature of the cool pack air and the temperature of the warm recirculation air. A fine adjustment of the mixed air temperature may be achieved by suitable control of the supply of cool pack air and of the supply of warm recirculation air to the mixing chamber. Typical mixed air temperatures are in the range of between +10 and +15° C.

The aircraft air conditioning system further comprises an inlet line, which is connected to a connection on the aircraft for an aircraft-external air production unit, preferably a conventional low-pressure air unit. The connection on the aircraft for the aircraft-external air unit may be arranged, for example, in the area of a wing root or in the area of a belly fairing of the aircraft. The inlet line opens into the pack air line connecting the air conditioning unit to the mixing chamber. In the aircraft air conditioning system the inlet line is thus not connected directly to the mixing chamber of the aircraft air conditioning system, as in conventional aircraft air conditioning systems. Instead of this, air provided by an aircraft-external air production unit can be introduced via the inlet line into the pack air line upstream of the mixing chamber. Unless otherwise indicated, the terms “upstream” and “downstream” in the context of this application refer to the flow direction of the pack air produced by the air conditioning unit and of the air produced by the aircraft-external air production unit through the pack air line.

Finally, the aircraft air conditioning system comprises an air conditioning air line, which branches off from the pack air line between an opening point of the inlet line into the pack air line and the mixing chamber and is connectable to an aircraft area to be cooled. The cool air flowing through the pack air line can thus be conducted via the air conditioning air line into the aircraft area to be cooled directly, i.e. before premixing of the cool air with warm recirculation air in the mixing chamber of the aircraft air conditioning system. The aircraft area to be cooled may be a hold area serving as a cool room, for example, to which cold air must be supplied at a temperature that is lower than the temperature of the mixed air emerging from the mixing chamber.

The configuration of the aircraft air conditioning system with an inlet line, which opens into the pack air line upstream of the mixing chamber, and an air conditioning air line, which branches off from the pack air line between the opening point of the inlet line into the pack air line and the mixing chamber, i.e. still upstream of the mixing chamber, makes it possible in ground operation of an aircraft that is equipped with the aircraft air conditioning system to conduct air conditioning air, which has been supplied to the inlet line by an aircraft-external air production unit, via the air conditioning air line directly to the aircraft area to be cooled without the air conditioning air being mixed in advance with recirculation air in the mixing chamber and being heated in the process. The air conditioning air provided by the aircraft-external air production unit can thus be used also to cool aircraft areas to which air must be supplied at a temperature that is lower than the temperature of the mixed air emerging from the mixing chamber. An additional operation of the air conditioning unit of the aircraft air conditioning system to provide these aircraft areas with air conditioning air is no longer necessary, therefore. This makes it possible to realize fuel and thus cost savings.

The inlet line preferably opens into the pack air line downstream of a non-return valve arranged in the pack air line. Such an arrangement of the opening point of the inlet line into the pack air line prevents air conditioning air, which is produced by an aircraft-external air production unit and conducted via the inlet line into the pack air line, from flowing in an undesirable manner in the direction of the air conditioning unit without additional components having to be provided for this, such as an additional non-return valve in the pack air line, for example.

In a preferred embodiment of the aircraft air conditioning system, the inlet line is connected to a housing of a non-return valve arranged in the pack air line. The connection of the inlet line to the normally structurally similarly executed housing of the non-return valve arranged in the pack air line makes it possible to eliminate additional support or bearing components for the inlet line. The inlet line can then be designed to be particularly lightweight. The connection of the inlet line to the housing of the non-return valve arranged in the pack air line is preferably configured so that the air conditioning air flowing through the inlet line opens into the pack air line downstream of a valve flap of the non-return valve arranged in the pack air line. As discussed above, an additional non-return valve, which prevents the air conditioning air flowing through the inlet line from flowing in the direction of the air conditioning unit, can be dispensed with by this.

A further non-return valve may be arranged in the inlet line. The non-return valve arranged in the inlet line prevents air conditioning air, which is produced by the air conditioning unit and conducted via the pack air line into the mixing chamber, from escaping through the inlet line.

In known aircraft air conditioning systems, the mixing chamber of the aircraft air conditioning system is often provided with only one connection, via which air conditioning air produced by an aircraft-external air production unit and/or emergency ventilation air supplied via a ram air duct can be supplied to the mixing chamber in dependence of the operating mode of the aircraft and of the aircraft air conditioning system. The emergency ventilation air supplied via the ram air duct is used, in the event of a failure of the air conditioning units in flight mode of the aircraft, to guarantee the supply of a minimum volume flow of air to the aircraft air conditioning system and to the aircraft areas to be air conditioned. In contrast to this, the aircraft air conditioning system described here is preferably equipped with an emergency ventilation line formed separately from the inlet line, which ventilation line is connected to a ram air duct and opens into the mixing chamber of the aircraft air conditioning system. Due to the separate configuration of the inlet line and the emergency ventilation line, a non-return valve provided in the emergency ventilation line in known aircraft air conditioning systems can be dispensed with, as it is no longer necessary to prevent air conditioning air to be supplied to the mixing chamber of the aircraft air conditioning system via the inlet line from escaping via the emergency ventilation line and the ram air duct.

The aircraft air conditioning system may generally be configured in such a way that only cool air conditioning air can flow through the air conditioning air line, which air is provided, depending on the operating mode of the aircraft air conditioning system, by the air conditioning unit or an aircraft-external air production unit. This is the case if the pack air line is connected or connectable only to the air conditioning unit and/or the aircraft-external air production unit upstream of a branching-off point of the air conditioning air line from the pack air line. Alternatively to this, however, it is also possible to configure the aircraft air conditioning system in such a way that a further recirculation air line adapted to be flown through with recirculation air opens into the pack air line between the opening point of the inlet line into the pack air line and a branching-off point of the air conditioning air line from the pack air line.

Via the further recirculation air line, a desired quantity of warm recirculation air can then be added to the air conditioning air, which can be supplied by the air conditioning unit or the aircraft-external air production unit and flows through the pack air line, before the air conditioning air is conducted via the air conditioning air line to the aircraft area to be cooled. This facilitates an especially flexible adjustment of the temperature of the air supplied to the aircraft area to be cooled without the temperature of the air conditioning air provided by the air conditioning unit or the aircraft-external air production unit having to be changed for this. Alternatively to this, however, it is also conceivable to adapt the temperature of the air conditioning air provided by the air conditioning unit or the aircraft-external air production unit to the cooling requirement of the aircraft area to be cooled without changing the quantity of recirculation air. In the event of a high cooling requirement in the aircraft area to be cooled, the air conditioning unit or the aircraft-external air production unit must then be operated at a correspondingly low temperature. To set a desired mixer temperature, a second air conditioning unit can then be operated at a correspondingly higher temperature.

A system for cooling an aircraft area comprises an aircraft air conditioning system described above and an aircraft-external air production unit, which is connectable via the connection on the aircraft to the inlet line of the aircraft air conditioning system.

In a method for operating a system for the cooling of an aircraft area using an aircraft air conditioning system, which comprises an air conditioning unit connected to a pack air line for producing air conditioning air, a recirculation air line adapted to be flown through with recirculation air and a mixing chamber, which is connected to the pack air line and the recirculation air line, and using an aircraft-external air production unit during ground operation of an aircraft equipped with the aircraft air conditioning system and connected to the aircraft-external air production unit, air conditioning air produced by the aircraft-external air production unit is conducted via an inlet line, which is connected to a connection on the aircraft for the aircraft-external air production unit, into the pack air line connecting the air conditioning unit to the mixing chamber. The air conditioning air produced by the aircraft-external air production unit is then supplied via an air conditioning air line, which branches off from the pack air line between an opening point of the inlet line into the pack air line and the mixing chamber, to an aircraft area to be cooled.

The air conditioning air produced by the aircraft-external air production unit is preferably conducted into the pack air line via the inlet line downstream of a non-return valve arranged in the pack air line.

The inlet line may be connected to a housing of a non-return valve arranged in the pack air line.

A further non-return valve arranged in the inlet line preferably prevents an escape of air conditioning air, which is produced by the air conditioning unit and conducted to the mixing chamber via the pack air line.

An emergency ventilation line connected to a ram air duct preferably opens into the mixing chamber.

Via a further recirculation line, adapted to be flown through with recirculation air opening into the pack air line between the opening point of the inlet line into the pack air line and a branching-off point of the air conditioning air line from the pack air line, recirculation air may be added to the air conditioning air produced by the aircraft-external air production unit and conducted into the pack air line via the inlet line.

### BRIEF DESCRIPTION OF THE DRAWINGS

Preferred embodiments of the disclosure herein are now explained in greater detail with reference to the enclosed schematic drawings, of which:

FIG. 1 shows a schematic representation of a first embodiment of a system for cooling an aircraft area;

FIG. 2 shows a schematic representation of a second embodiment of a system for cooling an aircraft area;

FIG. 3 shows a three-dimensional detailed representation of a part of the air conditioning system for cooling an aircraft area according to FIG. 2; and

FIG. 4 shows a schematic representation of a third embodiment of a system for cooling an aircraft area.

### DETAILED DESCRIPTION

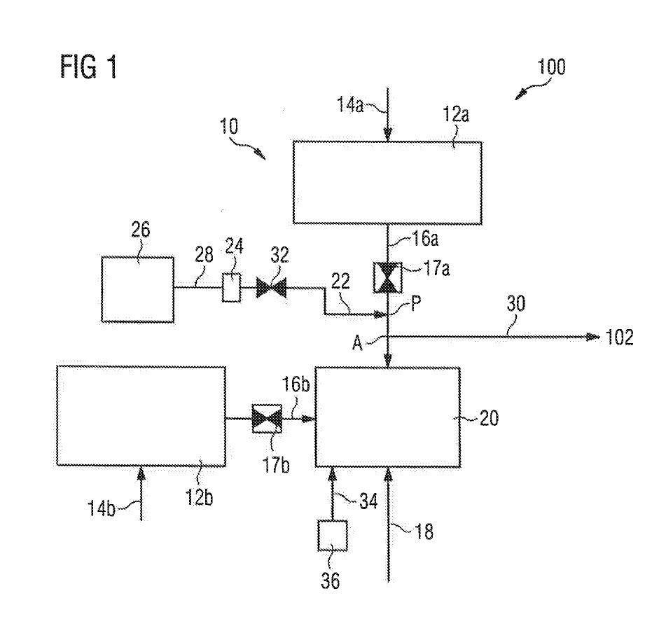

A system 100 shown in FIG. 1 for cooling an aircraft area 102 comprises an aircraft air conditioning system 10. The aircraft air conditioning system 10 has two air conditioning units 12a, 12b for producing air conditioning air. An input side of each air conditioning unit 12a, 12b is connected via a process air line 14a, 14b to an engine, an auxiliary power unit or a compressor (not shown) formed separately from the engine and the auxiliary power unit. Highly compressed process air is supplied via the process air line 14a, 14b to each air conditioning unit 12a, 12b, which air is cooled and expanded when it flows through the air conditioning unit 12a, 12b.

An output side of each air conditioning unit 12a, 12b is connected to a pack air line 16a, 16b, via which cooled air conditioning air emerging from the air conditioning unit 12a, 12b, which air has a temperature of approximately −15° C., for example, is led away from the air conditioning unit 12a, 12b. Arranged in each pack air line 16a, 16b is a non-return valve 17a, 17b, which prevents an undesirable flow of air conditioning air back through the respective pack air line 16a, 16b to the respective air conditioning unit 12a, 12b during operation of the air conditioning units 12a, 12b.

The aircraft air conditioning system 10 further comprises a recirculation air line 18, through which warm recirculation air carried away from an air-conditioned aircraft area, for example an aircraft passenger cabin, flows. The recirculation air flowing through the recirculation air line 18 normally has a temperature of approximately +30° C. Like the pack air lines 16a, 16b, the recirculation air line 18 is connected to a mixing chamber 20. In the mixing chamber 20, the cool air conditioning air produced by the air conditioning units 12a, 12b is mixed with the comparatively warm recirculation air carried away from the air-conditioned aircraft area. Mixed air emerging from the mixing chamber 20 consequently has a temperature that lies between the temperature of the cool air conditioning air and the temperature of the warm recirculation air, for example a temperature of between +10 and +15° C.

The aircraft air conditioning system 10 further comprises an inlet line 22, which is connected to a connection 24 on the aircraft for an aircraft-external air production unit 26, formed for example in the form of a low-pressure air production unit. The aircraft-external air production unit 26 is connected via a connection pipe 28 to the standardized connection 24 on the aircraft, so that cold air conditioning air produced by the air production unit 26 can be conducted via the connection pipe 28 and the connection 24 on the aircraft into the inlet line 22.

The inlet line 22 opens into a first pack air line 16a connecting a first air conditioning unit 12a to the mixing chamber 20. The cold air conditioning air produced by the air production unit 26 can thus be introduced from the inlet line 22 upstream of the mixing chamber 20 into the first pack air line 16a. Finally, the aircraft air conditioning system 10 comprises an air conditioning air line 30, which branches off from the pack air line between an opening point P of the inlet line 22 into the pack air line 16a and the mixing chamber 20 and is connected to the aircraft area 102 to be cooled. The aircraft area 102 to be cooled may be a hold area serving as a cool room, for example, to which cold air must be supplied at a temperature that is lower than the temperature of the mixed air emerging from the mixing chamber 20.

The configuration of the aircraft air conditioning system 10 with an inlet line 22, which opens into the first pack air line 16a upstream of the mixing chamber 20, and an air conditioning air line 30, which branches off from the first pack air line 16a between the opening point P of the inlet line 22 into the first pack air line 16a and the mixing chamber 20, i.e. still upstream of the mixing chamber 20, makes it possible during ground operation of an aircraft equipped with the system 100 to conduct air conditioning air supplied to the inlet line 22 by the aircraft-external air production unit 26 via the air conditioning air line 30 directly to the aircraft area 102 to be cooled, without the air conditioning air being mixed previously with recirculation air in the mixing chamber 20 and being warmed in the process. The air conditioning air provided by the aircraft-external air production unit 26 can thus be used also for cooling aircraft areas 102 to which air has to be carried at a temperature that is lower than the temperature of the mixed air emerging from the mixing chamber 20.

In the arrangement according to FIG. 1, the inlet line 22 opens into the first pack air line 16a downstream of a first non-return valve 17a arranged in the first pack air line 16a. An arrangement of this kind of the opening point P of the inlet line 22 into the first pack air line 16a prevents air conditioning air, which is produced by the aircraft-external air production unit 26 and is conducted via the inlet line 22 into the first pack air line 16a, from flowing in an undesirable manner in the direction of the first air conditioning unit 12a. A further non-return valve 32 arranged in the inlet line 22 prevents air conditioning air, which was produced by the first air conditioning unit 12a and conducted via the first pack air line 16a into the mixing chamber 20, from escaping through the inlet line 22, especially during flight operation of the aircraft.

Finally, the aircraft air conditioning system 10 is equipped with an emergency ventilation line 34 formed separately from the inlet line 22, which ventilation line is connected to a ram air duct 36 and opens into the mixing chamber 20 of the aircraft air conditioning system 10. Due to the separate configuration of the inlet line 22 and the emergency ventilation line 34, a non-return valve provided in the emergency ventilation line 34 in known aircraft air conditioning systems can be eliminated, as air conditioning air flowing through the inlet line 22 no longer has to be prevented from escaping via the emergency ventilation line 34 and the ram air duct 36.

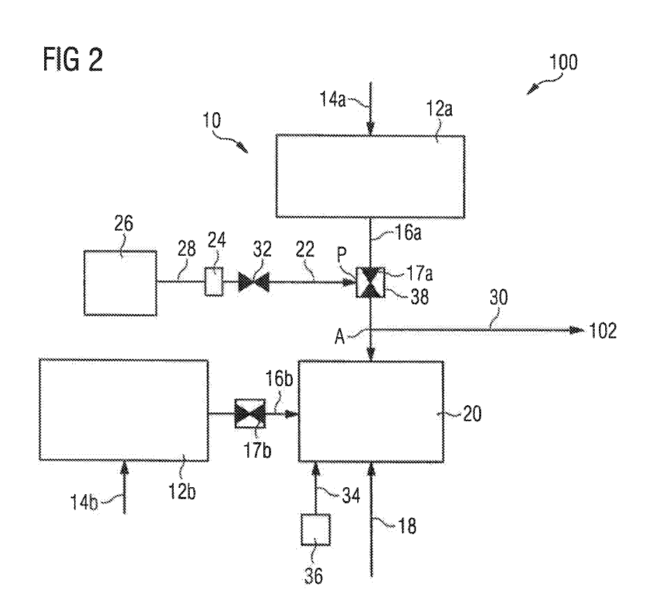

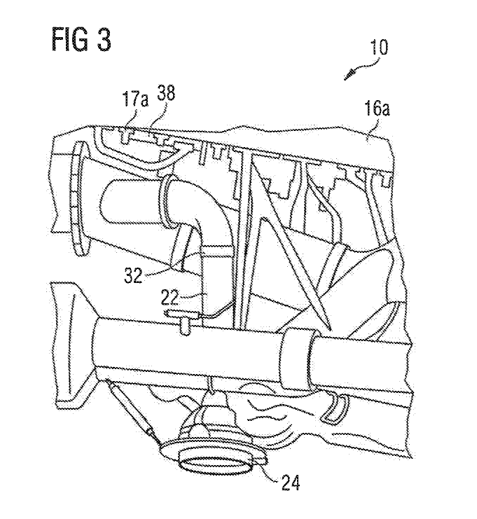

The system 100 illustrated in FIGS. 2 and 3 for cooling an aircraft area 102 differs from the arrangement according to FIG. 1 in that the inlet line 22 does not open into the first pack air line 16a downstream of the first non-return valve 17a arranged in the first pack air line 16a, but is connected to a housing 38 of the first non-return valve 17a arranged in the first pack air line 16a. The connection of the inlet line 22 to the structurally similarly executed housing 38 of the first non-return valve 17a makes it possible to dispense with additional support or bearing components for the inlet line 22.

The connection of the inlet line 22 to the housing 38 of the first non-return valve 17a is configured in such a way, however, that air conditioning air flowing through the inlet line 22 emerges into the first pack air line 16a downstream of a valve flap (not shown) of the first non-return valve 17a. Due to this, as discussed above, an additional non-return valve, which prevents the air conditioning air flowing through the inlet line 22 from flowing in the direction of the first air conditioning unit 12a, can be eliminated. The construction and mode of operation of the system 100 shown in FIGS. 2 and 3 otherwise correspond to the construction and mode of operation of the arrangement according to FIG. 1.

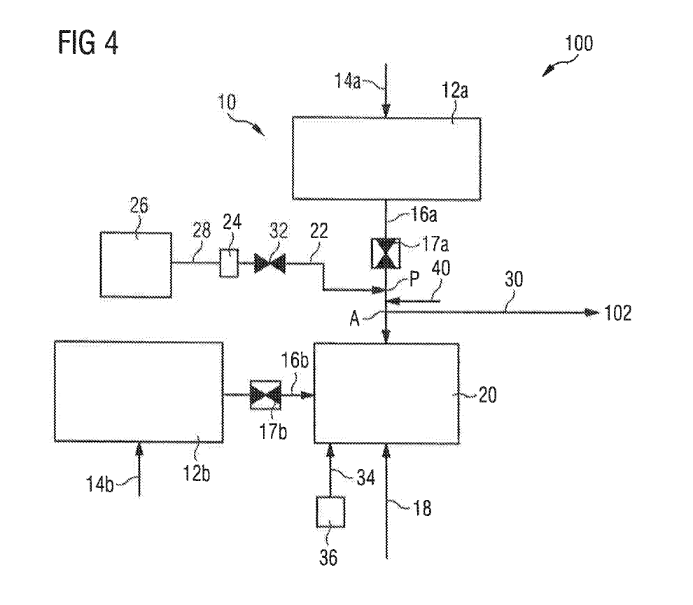

In the systems 100 illustrated in FIGS. 1 through 3 for cooling an aircraft area 102, only cool air conditioning air, which is provided by the first air conditioning unit 12a or the aircraft-external air production unit 26 depending on the operating mode of the aircraft air conditioning system 10, flows through the air conditioning air line 30. In contrast to this, in the system 100 shown in FIG. 4 for cooling an aircraft area 102, a further recirculation air line 40 adapted to be flown through with recirculation air opens into the first pack air line 16a between the opening point P of the inlet line 22 into the first pack air line 16a and a branching-off point A of the air conditioning air line 30 from the first pack air line 16a. The air conditioning air flowing through the first pack air line 16a, which is provided by the first air conditioning unit 12a or the aircraft-external air production unit 26, can have a desired quantity of warm recirculation air added to it via the further recirculation air line 40 before the air conditioning air is conducted via the air conditioning air line 30 into the aircraft area 102 to be cooled. This facilitates a flexible adjustment of the temperature of the air supplied to the aircraft area 102 that is to be cooled, without the temperature of the air conditioning air provided by the first air conditioning unit 12a or the aircraft-external air production unit 26 having to be changed for this.

Alternatively to this, the temperature of the air conditioning air provided by the first air conditioning unit 12a or the aircraft-external air production unit 26 can also be adjusted to the cooling requirement of the aircraft area 102 to be cooled without changing the quantity of recirculation air flowing through the recirculation air line 40. In the event of a high cooling requirement in the aircraft area 102 to be cooled, the first air conditioning unit 12a or the aircraft-external air production unit 26 must then be operated at a correspondingly low temperature. To set a desired mixer temperature, the second air conditioning unit 12b can then be operated at a correspondingly higher temperature. The construction and mode of operation of the system 100 shown in FIG. 4 otherwise corresponds to the construction and mode of operation of the arrangement according to FIG. 1.

The features of the embodiments described here of a system 100 for cooling an aircraft area 102 can be combined with one another in any way. For example, the system 100 illustrated in FIGS. 2 and 3 can be provided with a further recirculation air line 40. In a similar manner, the system 100 can be altered according to FIG. 4 in such a way that the inlet line 22, similarly to the system 100 according to FIGS. 2 and 3, is connected to a housing 38 of the first non-return valve 17a arranged in the first pack air line 16a.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, an or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft air conditioning system comprising:
an air conditioning unit for production of air conditioning air, the unit being connected to a pack air line;
a recirculation air line adapted to be flown with recirculation air;
a mixing chamber connected to the pack air line and the recirculation air line;
an inlet line connected to a connection on the aircraft for an aircraft-to external air production unit and opening into the pack air line connecting the air conditioning unit to the mixing chamber; and
an air conditioning air line which branches off from the pack air line between an opening point of the inlet line into the pack air line and the mixing chamber and is connectable to an aircraft area to be cooled.

2. The aircraft air conditioning system according to claim 1, wherein the inlet line opens into the pack air line downstream of a non-return valve arranged in the pack air line.

3. The aircraft air conditioning system according to claim 1, wherein the inlet line is connected to a housing of a non-return valve arranged in the pack air line.

4. The aircraft air conditioning system according to claim 1, wherein another non-return valve is arranged in the inlet line.

5. The aircraft air conditioning system according to claim 1, wherein an emergency ventilation line connected to a ram air duct opens into the mixing chamber.

6. The aircraft air conditioning system according to claim 1, wherein a further recirculation air line adapted to be flown through with recirculation air opens into the pack air line between the opening point of the inlet line into the pack air line and a branching-off point of the air conditioning air line from the pack air line.

7. A system for cooling an aircraft area, the system comprising:
an aircraft air conditioning system comprising:
an air conditioning unit for production of air conditioning air, the unit being connected to a pack air line;
a recirculation air line adapted to be flown with recirculation air;
a mixing chamber connected to the pack air line and the recirculation air line;
an inlet line connected to a connection on the aircraft for an aircraft-external air production unit and opening into the pack air line connecting the air conditioning unit to the mixing chamber; and
an air conditioning air line which branches off from the pack air line between an opening point of the inlet line into the pack air line and the mixing chamber and is connectable to an aircraft area to be cooled; and
an aircraft-external air production unit connected to the inlet line of the aircraft air conditioning system via the connection on the aircraft.

8. A method for operating a system for cooling an aircraft area comprising:
an aircraft air conditioning system, which comprises an air conditioning unit connected to a pack air line for the production of air conditioning air, a recirculation air line adapted to be flown through with recirculation air and a mixing chamber, which is connected to the pack air line and the recirculation air line; and
an aircraft-external air production unit;
wherein, in the method during ground operation of an aircraft equipped with the aircraft air conditioning system and connected to the aircraft-external air production unit:
air conditioning air produced by the aircraft-external air production unit is conducted via an inlet line connected to a connection on the aircraft for the aircraft-external air production unit, into the pack air line connecting the air conditioning unit to the mixing chamber, and
the air conditioning air produced by the aircraft-external air production unit is then supplied via an air conditioning air line, which branches off from the pack air line between an opening point of the inlet line into the pack air line and the mixing chamber, to the aircraft area to be cooled.

9. The method according to claim 8,
wherein the air conditioning air produced by the aircraft-external air production unit is conducted into the pack air line via the inlet line downstream of a non-return valve arranged in the pack air line.

10. The method according to claim 8, wherein the inlet line is connected to a housing of a non-return valve arranged in the pack air line.

11. The method according to claim 8, wherein a further non-return valve arranged in the inlet line prevents an escape of air conditioning air, which is produced by the air conditioning unit and is conducted via the pack air line into the mixing chamber.

12. The method according to claim 8, wherein an emergency ventilation line connected to a ram air duct opens into the mixing chamber.

13. The method according to claim 1, wherein recirculation air is added to the air conditioning air, which is produced by the aircraft-external air production unit and conducted via the inlet line to the pack air line, via a further recirculation air line adapted to be flown through with recirculation air and opening into the pack air line between the opening point of the inlet line into the pack air line and a branching-off point of the air conditioning air line from the pack air line.
